(19) United States
(12) Patent Application Publication
(10) Pub. No.: US 2018/0033315 A1
(43) Pub. Date: Feb. 1, 2018

(54) SYSTEMS AND METHODS FOR TRANSPORTING PRODUCTS VIA UNMANNED AERIAL VEHICLES AND MOBILE RELAY STATIONS

(71) Applicant: Wal-Mart Stores, Inc., Bentonville, AR (US)

(72) Inventor: David C. Winkle, Bella Vista, AR (US)

(21) Appl. No.: 15/658,837

(22) Filed: Jul. 25, 2017

Related U.S. Application Data
(60) Provisional application No. 62/367,393, filed on Jul. 27, 2016.

(51) Int. Cl. G08G 5/00; B60L 11/18; B64C 39/02

(52) U.S. Cl. CPC G08G 5/0043; B64C 39/024; B60L 11/1824; B64C 2201/128; G06Q 10/083

(57) ABSTRACT

In some embodiments, methods and systems of delivering products from a first location to at least a second location include at least one unmanned aerial vehicle configured to transport at least one of the products from the first location to the second location along a predetermined route and at least one mobile relay station including at least one charging dock and configured to accommodate and charge the at least one unmanned aerial vehicle. A central computing device including a processor-based control circuit is configured to communicate with the unmanned aerial vehicle and the mobile relay station via a network. The mobile relay station is configured to move into a position on the predetermined route of the unmanned aerial vehicle to permit the unmanned aerial vehicle to land on the mobile relay station that is moved into the predetermined route of the unmanned aerial vehicle.

### CROSS-REFERENCE TO RELATED APPLICATION

This application claims the benefit of U.S. Provisional Application No. 62/367,393, filed Jul. 27, 2016, and is incorporated herein by reference in its entirety.

### TECHNICAL FIELD

This disclosure relates generally to transporting products and, in particular, to systems and methods for transporting products via unmanned aerial vehicles.

### BACKGROUND

Product transportation and delivery using unmanned aerial vehicles (UAVs) is becoming popular. Typical UAVs have limited delivery range, since they are battery-powered. Some UAV-based delivery systems utilize stationary charging stations installed on rooftops of buildings, cellular towers, and other secure facilities, where the UAV can land and recharge while traveling along their delivery route. Since drone delivery is becoming increasingly popular, and since the delivery routes of UAV's constantly vary due to the large numbers of customers in different locations that order products to be delivered by drone, such UAV-based delivery systems increasingly depend on building and installing more and more charging stations for UAVs, which significantly increases operation costs of such systems.

### BRIEF DESCRIPTION OF THE DRAWINGS

Disclosed herein are embodiments of systems, devices, and methods pertaining to methods and systems for transporting products via UAVs and mobile relay stations. This description includes drawings, wherein:

FIG. 1 is a diagram of a system for transporting products via UAVs and mobile relay stations in accordance with some embodiments;

FIG. 2 is a functional block diagram of a central computing device in accordance with some embodiments;

FIG. 3 comprises a block diagram of a UAV as configured in accordance with various embodiments of these teachings; and

FIG. 4 is a flow diagram of a method of transporting product-containing packages via UAVs and mobile relay stations in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally, the systems, devices, and methods described herein provide for transporting products via UAVs and a network of mobile relay stations configured to accommodate and charge UAVs docked thereto.

In one embodiment, a system for delivering products from a first location to at least a second location includes: at least one unmanned aerial vehicle configured to transport at least one of the products from the first location to the second location along a predetermined route; at least one mobile relay station including at least one charging dock, the at least one charging dock configured to accommodate and charge the at least one unmanned aerial vehicle; and a central computing device including a processor-based control circuit and configured to communicate with the at least one unmanned aerial vehicle and the at least one mobile relay station via a network; wherein the at least one mobile relay station is configured to move into a position on the predetermined route of the at least one unmanned aerial vehicle to permit the at least one unmanned aerial vehicle to land on the at least one mobile relay station that is moved into the predetermined route of the at least one unmanned aerial vehicle.

In another embodiment, a method of delivering products from a first location to at least a second location includes: providing at least one unmanned aerial vehicle; transporting at least one of the products from the first location to the second location via the at least one unmanned aerial vehicle along a predetermined route; providing at least one mobile relay station including at least one charging dock; accommodating and charging the at least one unmanned aerial vehicle at the at least one charging dock; providing a central computing device including a processor-based control circuit and configured to communicate with the at least one unmanned aerial vehicle and the at least one mobile relay station via a network; moving the at least one mobile relay station into a position on the predetermined route of the at least one unmanned aerial vehicle; and permitting the at least one unmanned aerial vehicle to land on the at least one mobile relay station that is moved into the predetermined route of the at least one unmanned aerial vehicle.

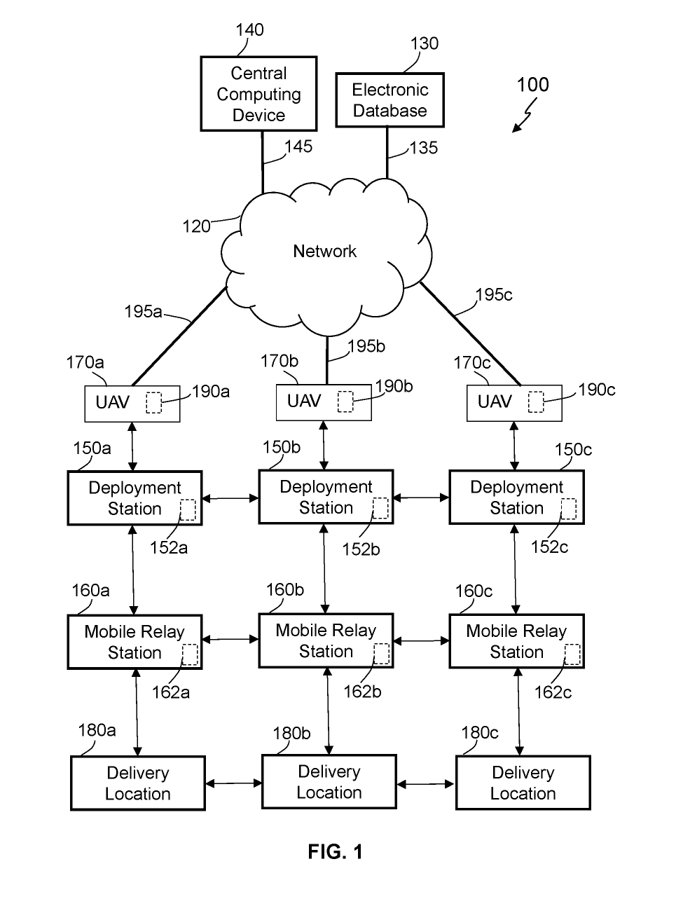

FIG. 1 illustrates an embodiment of a system 100 for transporting at least one product 190a-c from one or more deployment stations 150a-c to one or more delivery locations 180a-c via one or more unmanned aerial vehicles (UAVs) 170a-170c and one or more mobile relay stations 160a-c. It will be understood that the details of this example are intended to serve in an illustrative capacity and are not necessarily intended to suggest any limitations in regards to the present teachings.

Generally, the exemplary system 100 includes at least one UAV (three UAVs 190a-c are shown in FIG. 1) configured to lift, transport, and drop off at least one product (three products 190a-c are shown in FIG. 1), as well as at least one mobile relay station (three mobile relay stations 160a-e are shown in FIG. 1) configured to permit the UAVs 170a-c to land thereon and dock thereto in order to recharge while delivering the products 190a-c from at least one deployment station (three deployment stations 150a-c are shown in FIG. 1) to at least one delivery location (three delivery locations 180a-c are shown in FIG. 1). The exemplary system 100 also includes a processor-based central computing device 140 in two-way communication with the UAVs 170a-c and/or the mobile relay stations 160a-c via a communication channel 145 over the network 120, and an electronic database 130 in two-way communication with at least the central computing device 140 via a communication channel 135 over the network 120. It is understood that more or fewer of such components may be included in different embodiments of the system 100.

While the present application refers to products 190a-c as the objects being transported by the UAVs 170a-c, it will be appreciated that the principles described herein are applicable to any object other than a product 190a-c that may be transported by the UAVs 170a-c, including but not limited to product packaging, boxes, totes, bins or the like. Generally, the products 190a-c transported by the UAVs 170a-c may be any products that can be ordered by a consumer from a retailer. As shown via the unnumbered two-way arrows in FIG. 1, the products 190a-c may be transported from one or more deployment station 150a-c of a retailer to one or more delivery locations 180a-c. A delivery location 180a-c may be a home address of a consumer or a facility operated by the retailer, for example, a distribution center, warehouse, or retail store of the retailer. Generally, the UAVs 170a-c are configured to fly above ground through a space, to land onto a mobile relay station 160a-c, and to dock to the mobile relay station 160a-c for recharging, as described in more detail below.

The UAVs 170a-c deployed in the exemplary system 100 do not require physical operation by a human operator and wirelessly communicate with, and are wholly or largely controlled by, the central computing device 140. In particular, in some embodiments, the central computing device 140 is configured to control movement (e.g., flying, landing, taking off, etc.) of the UAVs 170a-c based on a variety of inputs. For example, the central computing device 140 is in two-way communication with the UAVs 170a-c (via communication channels 145 and 195a-c) over the network 120, which may be one or more wireless networks of one or more wireless network types (such as, a wireless local area network (WLAN), a wireless personal area network (PAN), a wireless mesh network, a wireless star network, a wireless wide area network (WAN), a local area network (LAN), a cellular network, and combinations of such networks, and so on), capable of providing wireless coverage of the desired range of the UAVs 170a-c according to any known wireless protocols, including but not limited to a cellular, Wi-Fi or Bluetooth network.

In some embodiments, as will be described below, the central computing device 140 is configured to transmit at least one signal to one or more UAVs 170a-c to cause the UAVs 170a-c to fly toward and land onto or take off from one or more mobile relay stations 160a-c in order to recharge and/or to transport one or more products 190a-c toward their respective delivery locations 180a-c. The central computing device 140 of the exemplary system 100 of FIG. 1 may be a stationary or portable electronic device, for example, a desktop computer, a laptop computer, a tablet, a mobile phone, or any other electronic device. In some embodiments, the central computing device 140 may comprise a control circuit, a central processing unit, a processor, a microprocessor, and the like, and may be one or more of a server, a central computing system including more than one computing device, a retail computer system, a cloud-based computer system, and the like. In the embodiment of FIG. 1, the central computing device 140 is configured for data entry and processing and for communication with other devices (e.g., UAVs 170a-c, mobile relay stations 160a-e, and deployment stations 150a-c) of system 100 via the network 120. In some aspects, the central computing device 140 is configured for two-way communication via the network 120 with hand-held electronic devices of workers responsible for loading the products 190a-c into the UAVs 170a-c at their deployment stations 150a-c. In some aspects, the central computing device 140 is configured for two-way communication via the network 120 with hand-held electronic devices of drivers of vehicles that transport the mobile relay stations 160a-c.

Generally, the central computing device 140 may be any processor-based device configured to communicate with the UAVs 170a-c, deployment stations 150a-c, and mobile relay stations 160a-160c in order to guide the UAVs 170c from their respective deployment stations 150a-c to their respective delivery locations 180a-c while docking at one or more mobile relay stations 160a-c to recharge, if necessary. The central computing device 140 may include a processor configured to execute computer readable instructions stored on a computer readable storage memory. The central computing device 140 may generally be configured to cause the UAVs 170a-c to: travel along a flight route determined by a control circuit of the central computing device 140 to a delivery location 180a-c; locate one or more mobile relay stations 160a-c positioned along the flight route predetermined by the central computing device 140, land on and/or dock to one or more mobile relay stations 160a-c to recharge, undock and/or lift off from the mobile relay stations 160a-c when recharging is complete, and land and drop off the products 190a-c at their respective delivery locations 180a-c. In some embodiments, the central computing device 140 may be configured to determine whether one or more landing conditions for the UAVs 170a-c are met prior to instructing the UAV's to land onto a mobile relation station 160a-c.

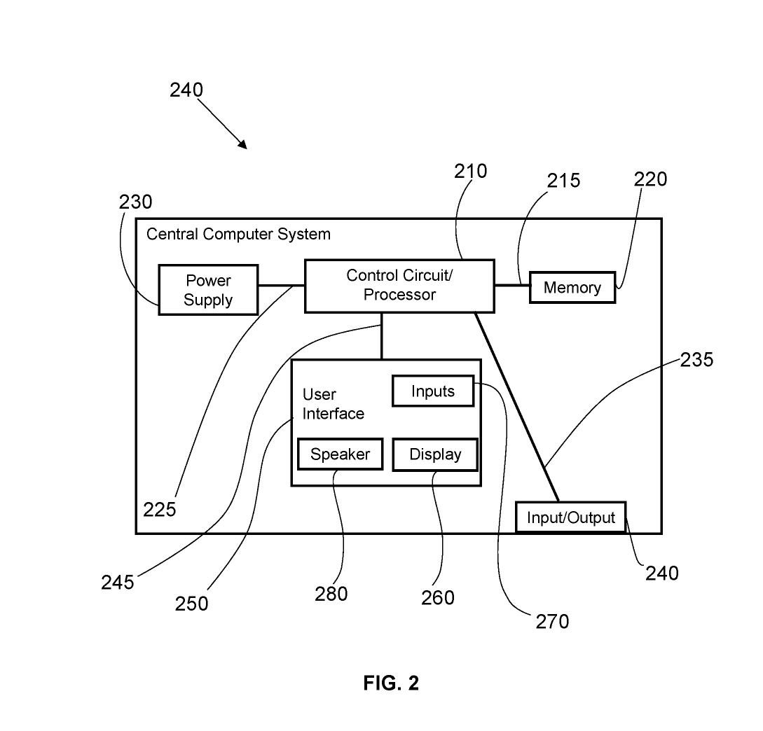

With reference to FIG. 2, the central computing device 140 configured for use with exemplary systems and methods described herein may include a control circuit 210 including a processor (e.g., a microprocessor or a microcontroller) electrically coupled via a connection 215 to a memory 220 and via a connection 225 to a power supply 230. The control circuit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

This control circuit 210 can be configured (for example, by using corresponding programming stored in the memory 220 as will be well understood by those skilled in the art) to carry out one or more of the steps, actions, and/or functions described herein. In some embodiments, the memory 220 may be integral to the processor-based control circuit 210 or can be physically discrete (in whole or in part) from the control circuit 210 and is configured non-transitorily store the computer instructions that, when executed by the control circuit 210, cause the control circuit 210 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control circuit may be referred to as a non-transitory medium or non-transitory computer readable medium.

The control circuit 210 of the central computing device 140 is also electrically coupled via a connection 235 to an input/output 240 (e.g., wireless interface) that can receive wired or wireless signals from one or more of the UAVs 170a-c. Also, the input/output 240 of the central computing device 140 can send signals to the UAVs 170a-c, such as signals including instructions indicating which mobile relay station 160a-c to land on for recharging along the predetermined flight route of the UAVs 170a-c to their respective delivery locations 180a-c.

In the embodiment shown in FIG. 2, the processor-based control circuit 210 of the central computing device 140 is electrically coupled via a connection 245 to a user interface 250, which may include a visual display or display screen 260 (e.g., LED screen) and/or button input 270 that provide the user interface 250 with the ability to permit an operator of the central computing device 140, such as a worker at a facility of the retailer where the system 100 is implemented, to manually control the central computing device 140 by inputting commands via touch-screen and/or button operation and/or voice commands to, for example, to send a signal to a UAV 170a-c to instruct the UAV 170a-c to: fly to a location of a mobile relay station 160a-c; control directional movement of the UAV 170a-c while the UAV 170a-c is in flight along a route predetermined by the central computing device 140; control and/or modify the flight route of the UAV 170a-c while the UAV 170a-c is in flight; land onto a mobile relay station 160a-c; drop off a product 190a-c at a mobile relay station 160a-c, pick up a product from a mobile relay station 160a-c; lift off a mobile relay station 160a-c, land at a delivery location 180a-c; and drop off a product 190a-c at a delivery location 180a-c. It will be appreciated that the performance of such functions by the processor-based control circuit 210 of the central computing device 140 is not dependent on actions of a human operator, and that the control circuit 210 may be programmed to perform such functions without being actively controlled by a human operator.

In some embodiments, the display screen 260 of the central computing device 140 is configured to display various graphical interface-based menus, options, and/or alerts that may be transmitted from and/or to the central computing device 140 in connection with various aspects of transporting products 190a-c by the UAVs 170a-c via the mobile relay stations 160a-c. The inputs 270 of the central computing device 140 may be configured to permit an operator to navigate through the on-screen menus on the central computing device 140 and make changes and/or updates to the routes and destinations of the UAVs 170a-c, as well as to make changes and/or updates to the locations of the mobile relay stations 160a-c. It will be appreciated that the display screen 260 may be configured as both a display screen and an input 270 (e.g., a touch-screen that permits an operator to press on the display screen 260 to enter text and/or execute commands.)

In some embodiments, the inputs 270 of the user interface 250 of the central computing device 140 may permit an operator to enter and configure a delivery order for a product 190a-c to a delivery location 180a-c for a UAV 170a-c. For example, an operator may use the user interface 250 to identify a delivery location 180a-c for a UAV 170a-c where products 190a-c are to be delivered, and/or to identify a location (e.g., positioning coordinates) of a mobile relay station 160a-c positioned along a delivery route of the UAV 170a-c to the delivery location 180a-c.

In some embodiments, the central computing device 140 automatically generates a travel route for one or more of the UAVs 170a-c from their origin (e.g., deployment station 150a-c) to their destination (e.g., delivery location 180a-c). In some embodiments, this route is based on a starting location of a UAV 170a-c (e.g., location of deployment station 150a-c of origin), the intended destination of the UAV 170a-c (e.g., delivery location 180a-c, or a suitable mobile relay station 160a-c along the predetermined or modified delivery route). In some aspects, the central computing device 140 may calculate multiple possible optimum routes. In some embodiments, the system 100 is capable of integrating 2D and 3D maps of the navigable space of the UAVs 170a-c with physical locations of objects at the origin/destination locations. Once the central computing device 140 maps all objects to specific locations using algorithms, measurements and global position system (GPS) geo-location, for example, grids may be applied sectioning off the maps into access ways and blocked sections, enabling the UAVs 170a-c to use such grids for navigation and recognition. The grids may be applied to 2D horizontal maps along with 3D models. Such grids may start at a higher unit level and then can be broken down into smaller units of measure by the central computing device 140 when needed to provide more accuracy.

In the embodiment shown in FIG. 1, the central computing device 140 is configured to access at least one electronic database 130. The central computing device 140 and the electronic database 130 may be implemented as separate physical devices as shown in FIG. 1 (which may be at one physical location or two separate physical locations), or may be implemented as a single device. In some embodiments, the electronic database 130 may be stored, for example, on non-volatile storage media (e.g., a hard drive, flash drive, or removable optical disk) internal or external to the central computing device 140, or internal or external to computing devices distinct from the central computing device 140. In some embodiments, the electronic database 130 is cloud-based.

The exemplary electronic database 130 of FIG. 1 is configured to store electronic data including, but not limited to: (1) data associated with the products 190a-c (e.g., location of origin of a product 190a-c, destination of the product 190a-c, size of the product 190a-c, location of the product 190a-c while being transported by a UAV 170a-c, as well as storage requirements for the product 190a-c, special instructions for the product 190a-c, etc.); (2) data associated with the UAVs 170a-c being used to transport the products 190a-c (e.g., location of each UAV 170a-c (e.g., GPS coordinates, etc.), identification of one or more products 190a-c in the UAV 170a-c, route of the UAV 170a-c from the deployment station 150a-c to the delivery location 180a-c, communication signals and/or messages sent between the central computing device 140 and the UAVs 170a-c, as well as any communications (e.g., messages and/or alerts) sent between the UAVs 170a-c and/or between the UAVs 170a-c and the mobile relay stations 160a-c); and (3) data associated with the mobile relay stations 160a-c (e.g., location of each mobile relay station 160a-c (e.g., GPS coordinates, etc.), identification of one or more UAVs 170a-c at each mobile relay station 160a-c, as well as communication signals and/or messages sent between the central computing device 140 and the mobile relay stations 160a-c).

In some embodiments, location inputs are provided via the network 120 to the central computing device 140 to enable the central computing device 140 to determine the location of one or more of the UAVs 170a-c and/or one or more mobile relay stations 160a-c and/or one or more products 190a-c. For example, in some embodiments, the UAVs 170a-c and/or the mobile relay stations 160a-c and/or the products 190a-c may include GPS tracking devices that permit a GPS-based identification of the location of the UAVs 170a-c and/or the mobile relay stations 160a-c and/or the products 190a-c by the central computing device 140 via the network 120. In one aspect, the central computing device 140 is configured to track the location of the UAVs 170a-c and the mobile relay stations 160a-c, and determine, via the control circuit 210, an optimal route for the UAVs 170a-c from their respective starting deployment stations 150a-c to their respective destination delivery locations 180a-c. In some embodiments, the control circuit 210 of the central computing device 140 is programmed to cause the central computing device 140 to communicate such tracking and/or routing data to the electronic database 130 for storage and/or later retrieval.

Generally, the UAVs 170a-c of FIG. 1 is configured to transport products 190a-c from a deployment station 150a-c to a delivery location 180a-c. While the UAVs 170 are generally described herein, in some embodiments, an aerial vehicle remotely controlled by a human may be utilized with the systems and methods described herein without departing from the spirit of the present disclosure. In some embodiments, the UAV 170a-c may be in the form of a multicopter, for example, a quadcopter, hexacopter, octocopter, or the like. In some embodiments, as described in more detail below, the UAV 170a-c includes a communication device (e.g., wireless transceiver) configured to communicate with the central computing device 140 while the UAV 170a-c is in flight and/or when docked at a mobile relay station 160a-c.

In some embodiments, as described in more detail below, the UAV 170a-c may comprise one or more mobile relay station-associated sensors including but not limited to: an optical sensor, a camera, an RFID scanner, a short range radio frequency transceiver, etc. Generally, the mobile relay station-associated sensors of the UAV 170a-c are configured to detect and/or identify a mobile relay station 160a-c based on guidance systems and/or identifiers of the mobile relay station 160a-c. For example, the mobile relay station-associated sensor of the UAV 170a-c may be configured to capture identifying information of the mobile relay station 160a-c from one or more of a visual identifier, an optically readable code, a radio frequency identification (RFID) tag, an optical beacon, and a radio frequency beacon.

In some embodiments, the UAV 170a-c may include other flight sensors such as optical sensors and radars for detecting obstacles in the path of flight to avoid collisions. While only three UAVs 170a-c are shown in FIG. 1 for ease of illustration, it will be appreciated that in some embodiments, the central computing device 140 may communicate with and/or provide flight route instructions to more than three (e.g., 10, 20, 50, 100, 1000, or more) UAVs simultaneously to guide the UAVs to transport products to their respective delivery locations and/or to dock to suitable mobile relay stations along a flight route predetermined and/or modified by the central computing device 140. Similarly, while only three deployment stations 150a-c, three mobile relay stations 160a-c, and three delivery locations 180a-c are shown in FIG. 1 for ease of illustration, it will be appreciated that in some embodiments, the system 100 may include more than three (e.g., 10, 20, 50, 100, 1000, or more) deployment stations, mobile relay stations, and delivery locations.

A deployment station 150a-c of FIG. 1 is generally a device configured to permit at least one UAV 170a-c to dock thereto for recharging. The deployment station 150a-c may be installed at a warehouse, retail facility, distribution center, or the like facilities from which products 190a-c may be delivered to another location (e.g., delivery location 180a-c) via UAVs 170a-c. Unlike the mobile relay stations 160a-c described below, the deployment stations 150a-c are stationary and not intended to be moved from their installed location. It will be appreciated that the stationary deployment stations 150a-c shown in FIG. 1 are optional to the system 100, and that in some embodiments, all stationary deployment stations 150a-c of FIG. 1 are replaced by mobile relay stations 160a-c, which in effect act as mobile deployment stations in such embodiments.

In one aspect, the deployment station 150a-c includes at least one charging dock 152a-c that enables at least one UAV 170a-c to connect thereto and charge. In some embodiments, a UAV 170a-c may couple to a charging dock 152a-c of a deployment station 150a-c while being supported by at least one support surface of the deployment station 150a-c. In one aspect, a support surface of the deployment station 150a-c may comprise one or more of a padded layer and a foam layer configured to reduce the force of impact associated with the landing of a UAV 170a-c onto the support surface of the deployment station 150a-c. In some embodiments, a deployment station 150a-c may include lights and/or guidance inputs recognizable by the sensors of the UAV 170a-c when located in the vicinity of the deployment station 150a-c. In some embodiments, the deployment station 150a-c may also include one or more coupling structures configured to permit the UAV 170a-c to detachably couple to the deployment station 150a-c while being coupled to a charging dock 152a-c of the deployment station 150a-c.

A mobile relay station 160a-c of FIG. 1 is generally a device configured to permit at least one UAV 170a-c to dock thereto and charge. Unlike the deployment station 150a-c described above, the mobile relay station 160a-c is a mobile device that is configured to be moved and/or to independently move into a position on a flight route predetermined by the central computing device 140 for a UAV 170a-c to permit the UAV 170a-c to land on the mobile relay station 160a-c that is moved into the predetermined route of the UAV 170a-c. In some aspects, the mobile relay station 160b may move or be moved into a position on a predetermined route of a UAV 170a flying from the mobile relay station 160a to the delivery location 180a. In other aspects, the mobile relay station 160b may move or be moved into a position on a predetermined route of a UAV 170a flying from the mobile relay station 160a to the mobile relay station 160c.

In some embodiments, a mobile relay station 160a-c may be located on a delivery truck of a retailer, such that the mobile relay station 160a-c moves from location to location as determined by the central computing device 140 when the delivery truck moves. In one aspect, the mobile relay station 160a-c may be removably attached to a body of any moving vehicle (truck, car, motorcycle, train, etc.). In another aspect, the mobile relay station 160a-c may be transported within a cargo space of any moving vehicle and taken out by an operator (e.g., driver), when appropriate, to enable one or more UAVs 170a-c to dock thereto at charging docks 162a-c. In some embodiments, a moving vehicle that facilitates movement of mobile relay stations 160a-c includes a GPS tracking device that permits a GPS-based identification of the location of the moving vehicle and/or the UAVs 170a-c by the central computing device 140 via the network 120.

In some embodiments, a UAV 170a-c is configured as a mobile relay station 160a-c including one or more charging docks 162a-c, such that the mobile relay station 160a-c may move by flying above ground, under guidance of the central computing device 140 (or a human operator), into a position (e.g., on the ground, on a roof of a building, on a balcony, on a storage container, on a landing area at a retailer-operated secure location, or the like) along a predetermined flight route of a UAV 170a-c without the aid of a separate moving vehicle to transport the mobile relay station 160a-c. In one aspect, an unmanned ground vehicle (UGV) may be configured as a mobile relay station 160a-c including one or more charging docks 162a-c, such that the mobile relay station 160a-c may move by moving on the ground, under guidance of the central computing device 140 (or a human operator), into a position along a predetermined flight route of a UAV 170a-c without the aid of a separate moving vehicle to transport the mobile relay station 160a-c.

In one aspect, the mobile relay station 160a-c includes at least one charging dock 162a-c that enables at least one UAV 170a-c to connect thereto. In some embodiments, a UAV 170a-c may couple to a charging dock 162a-c of a mobile relay station 160a-c while being supported by at least one support surface of the mobile relay station 160a-c. In one aspect, a support surface of the mobile relay station 160a-c may comprise one or more of a padded layer and a foam layer configured to reduce the force of impact associated with the landing of a UAV 170a-c onto a support surface of a mobile relay station 160a-c.

In some embodiments, the mobile relay station 160a-c is configured (e.g., by including a transceiver) to send a signal over the network 120 to the central computing device 140 to indicate if one or more charging docks 162a-c of the mobile relay station 160a-c are available to accommodate one or more UAVs 170a-c. In one aspect, the mobile relay station 160a-c is configured to send a signal over the network 120 to the central computing device 140 to indicate a number of charging docks 162a-c available for the UAV 170a-c on the mobile relay station 160a-c. In such situations, the control circuit 210 of the central computing device 140 is programmed to guide the UAV 170a-c to a mobile relay station 160a-c moved into position along the predetermined route of the UAV 170a-c and having at least one available charging dock 162a-c.

In some aspects, a signal received by the central computing device 140 from a mobile relay station 160a-c indicates that no charging docks 162a-c for the UAVs 170a-c are available at a mobile relay station 160a-c moved into position along the predetermined route of the UAV 170a-c. In such situations, the control circuit 210 of the central computing device 140 is programmed to determine an alternative mobile relay station 160a-c already located (or to be guided into position) along the predetermined route of the UAV 170a-c and having at least one available charging dock 162a-c, and to send a signal to the UAV 170a-c to direct the UAV 170a-c along a newly determined route to the alternative mobile relay station 160a-c having one or more available charging docks 162a-c. In some embodiments, the control circuit 210 of the central computing device 140 is configured to modify the predetermined route of a UAV 170a-c including a mobile relay station 160a-c not having available charging docks 162a-c by generating a modified route for the UAV 170a-c and sending a signal to the alternative mobile relay station 160a-c having available charging docks 162a-c to cause the alternative mobile relay station 160a-c having available charging docks 162a-c to move into a position on the modified route to enable the UAV 170a to dock to the alternative mobile relay station 160a-c.

In some embodiments, the mobile relay station 160a-c is configured to permit one UAV 170a-c to land thereon and/or to dock (e.g., via the charging dock 162a-c) thereto, and to release its respective product 190a-c therefrom onto a support surface of the mobile relay station 160a-c. In such embodiments, a second UAV 170a-c picks up the product 190a-c released by the first UAV 170a-c and transports the picked up product 190a-c from the mobile relay station 160a-c toward the next destination of the product 190a-c (which may be another mobile relay station 160a-c or a delivery location 180a-c). Such mobile relay stations 160a-c where the product 190a-cmay be dropped off by one UAV 170a-c and picked up by another UAV 170a-c advantageously reduce and/or eliminate delays that may be associated with recharging of the UAVs 170a-c while delivering products 190a-c over distances that exceed the range of the UAVs 170a-c.

In some embodiments, a mobile relay station 160a-c may include lights and/or guidance inputs recognizable by the sensors of the UAV 170a-c when located in the vicinity of the mobile relay station 160a-c. In some aspects, the mobile relay stations 160a-c and the UAVs 170a-c are configured to communicate with one another via the network (e.g., via their respective transceivers) to facilitate the landing of the UAVs 170a-c onto the mobile relay stations 160a-c. In other aspects, the transceivers of the mobile relay stations 160a-c enable the mobile rely stations to communicate with one another via the network 120. In some embodiments, the mobile relay station 160a-c may also include one or more coupling structures configured to permit the UAV 170a-c to detachably couple to the mobile relay station 160a-c while being coupled to a charging dock 162a-c of the mobile relay station 160a-c. It will be appreciated that the relative sizes and proportions of the deployment station 150a-c, mobile relay station 160a-c, UAV 170a-c, and products 190a-c in FIG. 1 are exemplary and are not drawn to scale. In some embodiments, the mobile relay stations 160a-c, UAVs 170a-c, and deployment stations 150a-c may comprise any size and shape without departing from the spirit of the present disclosure.

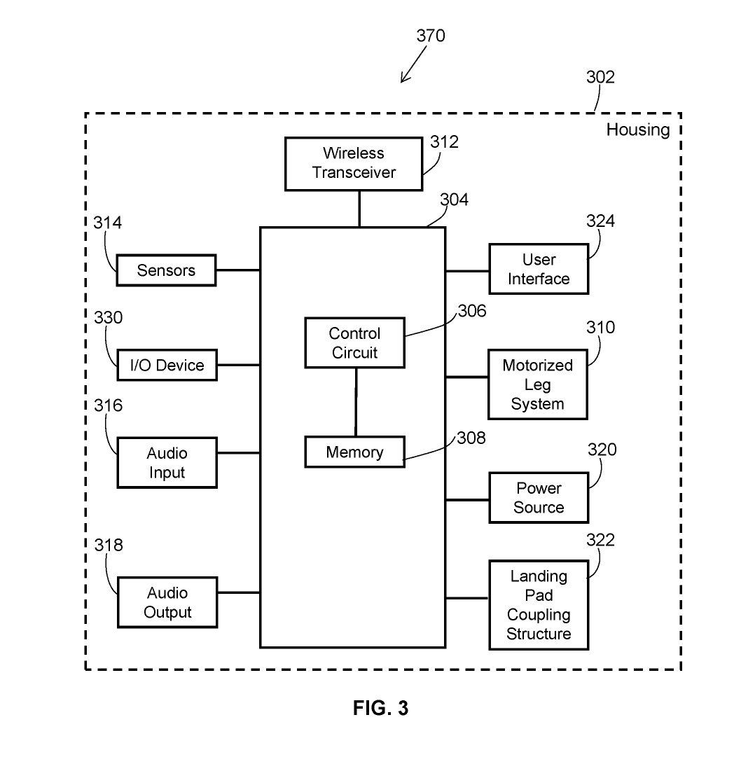

FIG. 3 presents a more detailed example of some embodiments of a UAV 370 identical to the UAVs 170a-c of FIG. 1. In this example, the UAV 370 has a housing 302 that contains (partially or fully) or at least supports and carries a number of components. These components include a control unit 304 comprising a control circuit 306 that, like the control circuit 210 of the central computing device 140, controls the general operations of the UAV 370. The control unit 304 includes a memory 308 coupled to the control circuit 306 for storing data such as operating instructions and/or useful data.

In some embodiments, the control circuit 306 operably couples to a motorized leg system 310. This motorized leg system 310 functions as a locomotion system to permit the UAV 370 to land onto the mobile relay station 160a-c and/or move laterally on the mobile relay station 160a-c. An exemplary motorized leg system usable with the system 100 is described in U.S. Provisional Application No. 62/331,854, filed May 4, 2016, incorporated by reference herein in its entirety. Various examples of motorized leg systems are known in the art. Further elaboration in these regards is not provided here for the sake of brevity save to note that the aforementioned control circuit 306 may be configured to control the various operating states of the motorized leg system 310 to thereby control when and how the motorized leg system 310 operates.

In the exemplary embodiment of FIG. 3, the control circuit 306 operably couples to at least one wireless transceiver 312 that operates according to any known wireless protocol. This wireless transceiver 312 can comprise, for example, a cellular-compatible, Wi-Fi-compatible, and/or Bluetooth-compatible transceiver that can wirelessly communicate with the central computing device 140 via the network 120. So configured, the control circuit 306 of the UAV 370 can provide information to the central computing device 140 (via the network 120) and can receive information and/or movement instructions from the central computing device 140. For example, the control circuit 306 can receive instructions from the central computing device 140 via the network 120 regarding directional movement (e.g., specific predetermined routes of movement) of the UAV 370 when transporting a product 190a-c to a from a mobile relay station 160a-c.

These teachings will accommodate using any of a wide variety of wireless technologies as desired and/or as may be appropriate in a given application setting. These teachings will also accommodate employing two or more different wireless transceivers 312, if desired. In some embodiments, the wireless transceiver 312 may be caused (e.g., by the control circuit 306) to transmit to the central computing device 140 at least one signal indicating that one or more products 190a-c have been picked up from (or dropped off onto) a mobile relay station 160a-c. In some aspects, the wireless transceiver 312 is configured to receive a signal from the central computing device 140 indicating a location (e.g., another mobile relay station 160a-c) where the product 190a-c picked up from the mobile relay station 160a-c is to be transported.

The control circuit 306 also couples to one or more on-board sensors 314 of the UAV 370. These teachings will accommodate a wide variety of sensor technologies and form factors. By one approach, the on-board sensors 314 can comprise at least one sensor configured to recognize the mobile relay station 160a-c and at least one sensor configured to detect whether the product 190a-c is present on the mobile relay station 160a-c. Such sensors 314 can provide information that the control circuit 306 and/or the central computing device 140 can employ to determine a present location and/or orientation of the UAV 370 relative to a mobile relay station 160a-c and/or to determine, for example, whether to direct a second UAV 370 to land on the mobile relay station 160a-c (e.g., to pick up a product 190a dropped off by a first UAV 370 on the mobile relay station 160a-c), or whether to direct the second UAV 370 not to land on the mobile relay station 160a-c (e.g., if the product 190a is not detected on the mobile relay station 160a-c). For example, the UAV 370 may include an on-board sensor 314 in the form of a video camera configured to detect whether the product 190a is present on the mobile relay station 160a-c or not.

In some embodiments, the on-board sensors 314 may include at least one sensor configured to detect a distance from the body of the UAV 370 to a mobile relay station 160a-c or to a product 190a-c located on the mobile relay station 160a-c. For example, the control circuit 306 of the UAV 370 may be programmed to determine, based on data received from such an on-board sensor 314 indicating the distance from the housing of the UAV 370 to the mobile relay station 160a-c and/or to the product 190a-c in order to enable the UAV 370 to land onto the mobile relay station 160a-c to drop off a products 190a-c for another UAV 370 or to pick up a product 190a-c dropped off by another UAV 370.

These teachings will accommodate any of a variety of distance measurement units including optical units and sound/ultrasound units. In one example, a sensor 314 comprises an altimeter and/or a laser distance sensor device capable of determining a distance to objects in proximity to the sensor. In some embodiments, the sensor 314 comprises an optical-based scanning device to sense and read optical patterns in proximity to the sensor, such as bar codes located on the mobile relay station 160a-c and/or on the product 190a-c. In some embodiments, the sensor 314 comprises a radio frequency identification (RFID) tag reader capable of reading RFID tags in proximity to the sensor. The foregoing examples are provided by way of example only and are not intended to convey an exhaustive listing of all possible distance sensors.

In some embodiments, the UAV 370 may detect objects along its path of travel using, for example, on-board sensors 314 such as sensors mounted on the UAV 370 and/or via communications with the central computing device 140. In some embodiments, the UAV 370 may attempt to avoid obstacles, and if unable to avoid, it will notify the central computing device 140 of such a condition. In some embodiments, using on-board sensors 314 (such as distance measurement units, e.g., laser or other optical-based distance measurement sensors), the UAV 370 detects obstacles in its path, and fly around such obstacles or to stop until the obstacle is clear.

By one optional approach, an audio input 316 (such as a microphone) and/or an audio output 318 (such as a speaker) can also operably couple to the control circuit 306 of the UAV 370. So configured, the control circuit 306 can provide for a variety of audible sounds to enable the UAV 370 to communicate with a mobile relay station 160a-c or other UAVs 370. Such sounds can include any of a variety of tones and other non-verbal sounds. Such audible sounds can also include, in lieu of the foregoing or in combination therewith, pre-recorded or synthesized speech.

In the embodiment illustrated in FIG. 3, the UAV 370 includes a rechargeable power source 320 such as one or more batteries. The power provided by the rechargeable power source 320 can be made available to whichever components of the UAV 370 require electrical energy. By one approach, the UAV 370 includes a plug or other electrically conductive interface that the control circuit 306 can utilize to automatically connect to an external source of electrical energy (e.g., charging docks 162a-c of mobile relay stations 160a-c) to recharge the rechargeable power source 320.

These teachings will also accommodate optionally selectively and temporarily coupling the UAV 370 to the mobile relay station 160a-c. In such a case, the UAV 370 can include a mobile relay station coupling structure 322. In one aspect, a mobile relay station 160a-c coupling structure 322 operably couples to a control circuit 306 to thereby permit the latter to control movement of the UAV 370 (e.g., via hovering and/or via the motorized leg system 310) towards a particular mobile relay station 160a-c until the mobile relay station coupling structure 322 can engage the mobile relay station 160a-c to thereby temporarily physically couple the UAV 370 to the mobile relay station 160a-c. So coupled, the UAV 370 can then pick up and/or drop off the product 190a-c from and/or onto the mobile relay station 160a-c.

In some embodiments, the motorized transport unit 360 includes an input/output (I/O) device 324 that is coupled to the control circuit 306. The I/O device 324 allows an external device to couple to the control unit 304. The function and purpose of connecting devices will depend on the application. In some examples, devices connecting to the I/O device 324 may add functionality to the control unit 304, allow the exporting of data from the control unit 304, allow the diagnosing of the UAV 370, and so on.

In some embodiments, the UAV 370 includes a user interface 326 including for example, user inputs and/or user outputs or displays depending on the intended interaction with the user (e.g., a worker at a distribution facility of a retailer and/or a driver of a vehicle that transports a mobile relay station 160a-c). For example, user inputs could include any input device such as buttons, knobs, switches, touch sensitive surfaces or display screens, and so on. Example user outputs include lights, display screens, and so on. The user interface 326 may work together with or separate from any user interface implemented at an optional user interface unit (such as a smart phone or tablet device) usable by a worker at a facility of a retailer or a delivery driver.

In some embodiments, the UAV 370 may be controlled by a user in direct proximity to the UAV 370 (e.g., a driver of a moving vehicle used for moving the mobile relay station 160a-c, or by a user at any location remote to the location of the UAV 370 (e.g., central hub operator). This is due to the architecture of some embodiments where the central computing device 140 outputs the control signals to the UAV 370. These controls signals can originate at any electronic device in communication with the central computing device 140. For example, the movement signals sent to the UAV 370 may be movement instructions determined by the central computing device 140 and/or initially transmitted by a device of a user to the central computing device 140 and in turn transmitted from the central computing device 140 to the UAV 370.

The control unit 304 of the UAV 370 includes a memory 308 coupled to a control circuit 306 and storing data such as operating instructions and/or other data. The control circuit 306 can comprise a fixed-purpose hard-wired platform or can comprise a partially or wholly programmable platform. These architectural options are well known and understood in the art and require no further description. This control circuit 306 is configured (e.g., by using corresponding programming stored in the memory 308 as will be well understood by those skilled in the art) to carry out one or more of the steps, actions, and/or functions described herein. The memory 308 may be integral to the control circuit 306 or can be physically discrete (in whole or in part) from the control circuit 306 as desired. This memory 308 can also be local with respect to the control circuit 306 (where, for example, both share a common circuit board, chassis, power supply, and/or housing) or can be partially or wholly remote with respect to the control circuit 306. This memory 308 can serve, for example, to non-transitorily store the computer instructions that, when executed by the control circuit 306, cause the control circuit 306 to behave as described herein. It is noted that not all components illustrated in FIG. 3 are included in all embodiments of the UAV 370. That is, some components may be optional depending on the implementation.

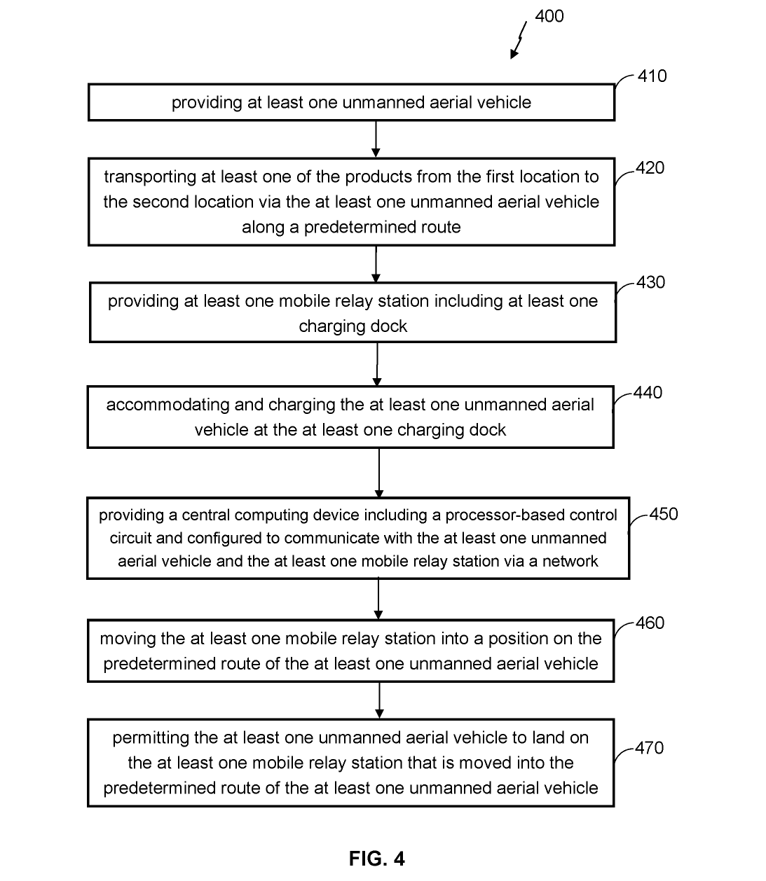

In view of the above description referring to FIGS. 1-3, and with reference to FIG. 4, a method 400 of delivering products from a first location to one or more other locations according to some embodiments will now be described. While the process 400 is discussed as it applies to the delivery of products 190a-c to delivery locations 180a-c via UAVs 170a-c and mobile relay stations 160a-c, as shown in FIGS. 1-3, it will be appreciated that the process 400 may be utilized in connection with any of the embodiments described herein.

The exemplary method 400 depicted in FIG. 4 includes providing one or more UAV 170a-c (step 410) and transporting one or more products 190a-c from a first location to a second location via the UAV 170a-c along a predetermined route (step 420). The method 400 also includes providing one or more mobile relay stations 160a-c including one or more charging dock 162a-c (step 430). As discussed above, in some embodiments, the step of providing one or more mobile relay stations 160a-c may include providing one or more UAVs or UGVs configured as mobile relay stations including one or more charging docks such that a separate moving vehicle is not required to move the mobile relay stations 160a-c to their positions along a flight route of a UAV 170a-c. In other embodiments, a separate moving vehicle is utilized to move the mobile relay stations 160a-c into the positions determined by the central computing device 140 along the predetermined flight route of a UAV 170a-c that transports the products 190a-c from a deployment station 150a-c to a delivery location 180a-c.

In one aspect, the first location may be a deployment station 150a-c and the second location may be a delivery location 180a-c. In another aspect, the first location may be a deployment station 150a-c and the second location may be a mobile relay station 160a-c. In yet another aspect, the first location may be one mobile relay station 160a-c and the second location may be another mobile relay station 160a-c. In yet another aspect, the first location may be a mobile relay station 160a-c and the second location may be a delivery location 180a-c. To that end, the method 400 includes accommodating and charging one or more UAVs 170a-c at one or more mobile relay stations 160a-c (step 440) as described above. In other words, during the course of a flight route determined by the central computing device 140 for a UAV 170a originating from deployment station 150a and delivering a product 190a to the delivery location 180a, the UAV 170a may be directed by the central computing device 140 to dock for recharging at any one, any two, all three of the mobile relay stations 160a-c in order to recharge. In some aspects, as described above, after the UAV 170a docks at a charging dock 162a of a mobile relay station 160a, the UAV 170a may drop off the product 190a at the mobile relay station 160a, and another UAV 170b may be directed by the central computing device 140 to pick up the product 190a dropped off by the UAV 170a, and to transport the product 190a to another mobile relay station or a delivery location.

The method 400 further includes providing a central computing device 140 including a processor-based control circuit 210 and configured to communicate with one or more UAV 170a-c and with one or more mobile relay station 160a-c via a network 120 (step 450). The central computing device 140 was described in detail above and generally tracks the locations of the UAVs 170a-c and the mobile relay stations 160a-c, and controls the movement of the UAVs 170a-c and the positioning of the mobile relay stations 160a-c to guide the UAVs 170a-c to their suitable mobile relay stations 160a-c along their delivery route and enable the recharging of the UAVs 170a-c while delivering the products 190a-c from their deployment stations 150a-c to their delivery locations 180a-c. It will be appreciated that while the mobile relay stations 160a-c and the deployment stations 150a-c are not connected to the network 120 by lines indicating a communication channel (akin to lines 135, 145, and 195a-c), each deployment station 150a-c and each mobile relay station 160a-c is configured for communication with the electronic database 130, central computing device 140, the UAVs 170a-c, and each other via the network 120.

The method 400 of FIG. 4 further includes moving one or more mobile relay stations 160a-c into a position on the predetermined route of the at least one UAV 170a-c (step 460) and permitting the one or more UAVs 170a-c to land on the one or more mobile relay stations 160a-c moved into the predetermined route of the one or more UAVs 170a-c (step 470). As discussed above, in some embodiments, the UAVs 170a-c and/or the mobile relay stations 160a-c include GPS tracking devices that permit a GPS-based identification of the location and tracking of the UAVs 170a-c and the mobile relay stations 160a-c by the central computing device 140 via the network 120. As also discussed above, in some embodiments, the central computing device 140 initially determines a flight route and controls the movement of the UAVs 170a-c from their respective starting deployment stations 150a-c to their respective destination delivery locations 180a-c while continuously tracking the location of the UAVs 170a-c. In addition, the central computing device 140 controls the movement of the mobile relay stations 160a-c while continuously tracking the location of the mobile relay stations 160a-c. In some aspects, the control circuit 210 of the central computing device 140 determines optimal positions of the mobile relay stations 160a-c along the predetermined delivery route of a UAV 170a-c toward its delivery location 180a-c, and sends signals over the network 120 to the mobile relay stations 160a-c to direct the mobile relay stations 160a-c to move into such optimal positions determined by the computing device 140. Since the central computing device 140 controls the movement of the UAVs 170a-c and the mobile relay stations 160a-c while continuously tracking the location of the UAVs 170a-c and the mobile relay stations 160a-c, the central computing device 140, not only causes the mobile relay stations 160a-c to move into optimal recharging positions along the delivery routes of the UAVs 170a-c, but, after directing the mobile relay stations 160a-c into the optimal charging positions, sends signals over the network 120 to the UAVs 170a-c to direct movement of the UAVs 170a-c in need of recharging to the mobile relay stations 160a-c that are directed to be positioned by the central computing device 140 along the delivery routes of the UAVs 170a-c to enable the UAVs 170a-c to dock to the mobile relay stations 160a-c in order to recharge and/or to drop off their products 190a-c for pick up by other UAVs 170a-c.

The systems and methods described herein advantageously provide for semi-automated or fully automated operation of unmanned aerial vehicles to transport products to consumers along predetermined delivery routes while enabling the recharging of the UAVs to advantageously extend the delivery range capabilities of the UAVs. The mobile relay stations are positioned in optimal locations along the predetermined delivery route of a UAV such that the UAV does not need to deviate from its optimal delivery route in order to recharge, advantageously increasing the efficiency of movement of the UAVs along their delivery routes. In addition, since the mobile relay stations permit the UAVs to drop off their products at the mobile relay station while being docked and recharging for pick up by other UAVs, the products can be advantageously delivered to the consumers faster (i.e., the products continue moving toward their delivery destination via another UAV while their original UAV is recharging at a mobile relay station).

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for delivering products from a first location to at least a second location, the system comprising:
at least one unmanned aerial vehicle configured to transport at least one of the products from the first location to the second location along a predetermined route;
at least one mobile relay station including at least one charging dock, the at least one charging dock configured to accommodate and charge the at least one unmanned aerial vehicle; and
a central computing device including a processor-based control circuit and configured to communicate with the at least one unmanned aerial vehicle and the at least one mobile relay station via a network;
wherein the at least one mobile relay station is configured to move into a position on the predetermined route of the at least one unmanned aerial vehicle to permit the at least one unmanned aerial vehicle to land on the at least one mobile relay station that is moved into the predetermined route of the at least one unmanned aerial vehicle.

2. The system of claim 1, wherein a first unmanned aerial vehicle is configured to release the at least one of the products after the first unmanned aerial vehicle lands on the mobile relay station, and wherein a second unmanned aerial vehicle is configured to pick up the at least one of the products released by the first unmanned aerial vehicle and to transport the picked up at least one of the products from the mobile relay station toward the second destination.

3. The system of claim 1, wherein the at least one mobile relay station is configured to send a signal over the network to the central computing device to indicate whether the at least one charging dock is available to accommodate the at least one unmanned aerial vehicle.

4. The system of claim 3, wherein, when the signal received at the central computing device from the at least one mobile relay station indicates that no charging docks are available on the at least one mobile relay station for the at least one unmanned aerial vehicle, the control circuit of the central computing device is programmed to determine an alternative mobile relay station along the predetermined route having at least one available charging dock and to send a signal to the at least one unmanned aerial vehicle directing the unmanned aerial vehicle to the alternative mobile relay station having the at least one available charging dock.

5. The system of claim 1, wherein the at least one mobile relay station is configured to send a signal over the network to the central computing device to indicate a number of available charging docks on the at least one mobile relay station.

6. The system of claim 1, wherein the at least one mobile relay station and the at least one unmanned aerial vehicle are configured to communicate to each other via the network.

7. The system of claim 1, wherein the control circuit of the central computing device is configured to modify the predetermined route in order to generate a modified route for the at least one unmanned aerial vehicle, and wherein the central computing device is configured to send at least one signal to the at least one mobile relation station to cause the at least one mobile relay station to move into a position on the modified route.

8. The system of claim 1, wherein the at least one mobile relay station is mounted on a vehicle, and wherein the central computing device is configured to track movement of the vehicle and the at least one mobile relay station mounted on the vehicle.

9. The system of claim 1, wherein the at least one unmanned aerial vehicle is configured as the at least one mobile relay station.

10. The system of claim 1, wherein a first unmanned aerial vehicle includes at least one charging dock configured to accommodate and charge a second unmanned aerial vehicle.

11. A method of delivering products from a first location to at least a second location, the method comprising:
providing at least one unmanned aerial vehicle;
transporting at least one of the products from the first location to the second location via the at least one unmanned aerial vehicle along a predetermined route;
providing at least one mobile relay station including at least one charging dock;
accommodating and charging the at least one unmanned aerial vehicle at the at least one charging dock;
providing a central computing device including a processor-based control circuit and configured to communicate with the at least one unmanned aerial vehicle and the at least one mobile relay station via a network;
moving the at least one mobile relay station into a position on the predetermined route of the at least one unmanned aerial vehicle; and
permitting the at least one unmanned aerial vehicle to land on the at least one mobile relay station that is moved into the predetermined route of the at least one unmanned aerial vehicle.

12. The method of claim 11, further comprising releasing the at least one of the products from a first of the unmanned aerial vehicles after the first unmanned aerial vehicle lands on the mobile relay station, picking up the at least one of the products released by the first unmanned aerial vehicle via a second unmanned aerial vehicle, and transporting the picked up at least one of the products from the mobile relay station toward the second destination.

13. The method of claim 11, further comprising sending a signal, from the at least one mobile relay station, over the network, to the central computing device to indicate whether the at least one charging dock is available to accommodate the at least one unmanned aerial vehicle.

14. The method of claim 13, further comprising, when the signal received at the central computing device from the at least one mobile relay station indicates that no charging docks are available on the at least one mobile relay station for the at least one unmanned aerial vehicle, determining, via the control circuit of the central computing device, an alternative mobile relay station along the predetermined route having at least one available charging dock, and sending a signal to the at least one unmanned aerial vehicle directing the unmanned aerial vehicle to the alternative mobile relay station having the at least one available charging dock.

15. The method of claim 11, further comprising sending a signal, from the at least one mobile relay station, over the network, to the central computing device to indicate a number of available charging docks on the at least one mobile relay station.

16. The system of claim 1, further comprising sending signals over the network between the at least one mobile relay station and the at least one unmanned aerial vehicle.

17. The method of claim 11, further comprising modifying, via the control circuit of the central computing device, the predetermined route in order to generate a modified route for the at least one unmanned aerial vehicle, and sending, from the central computing device, at least one signal to the at least one mobile relation station to cause the at least one mobile relay station to move into a position on the modified route.

18. The method of claim 11, further comprising mounting the at least one mobile relay station is mounted on a vehicle, and further comprising tracking, via the central computing device, movement of the vehicle and the at least one mobile relay station mounted on the vehicle.

19. The method of claim 11, further comprising configuring the at least one unmanned aerial vehicle as the at least one mobile relay station.

20. The method of claim 11, further comprising providing a first unmanned aerial vehicle including at least one charging dock configured to accommodate and charge a second unmanned aerial vehicle.
